(19) United States
(12) Patent Application Publication
(10) Pub. No.: US 2018/0301687 A1
(43) Pub. Date: Oct. 18, 2018

(54) METHOD FOR PREPARING CATHODE SLURRY OF LITHIUM ION BATTERY

(71) Applicant: HON HAI PRECISION INDUSTRY CO., LTD., New Taipei (TW)

(72) Inventors: MING-SHU KUO, New Taipei (TW); YU-HSUAN TANG, Tu-Cheng (TW); CHAN-HSIANG HSU, New Taipei (TW); PO-YEN CHEN, New Taipei (TW); CHIN-LUNG CHIU, New Taipei (TW); FENG-YUEN DAI, Tu-Cheng (TW)

(21) Appl. No.: 15/636,877

(22) Filed: Jun. 29, 2017

(30) Foreign Application Priority Data
Apr. 13, 2017 (TW) 106112369

(51) Int. Cl. H01M 4/04; H01M 4/62; H01M 4/136; H01M 4/139; H01M 10/0525

(52) U.S. Cl. CPC H01M 4/04; H01M 4/621; H01M 2004/028; H01M 4/139; H01M 10/0525; H01M 4/136

(57) ABSTRACT

A method for preparing cathode slurry of a lithium ion battery, includes: providing an cathode active substance; providing a conductive agent including carbon nanomaterials, agitating and dispersing the conductive agent in a dispersant to obtain a conductive agent suspension; providing a glue solution and dividing the glue solution into three parts; premixing and agitating the conductive agent suspension and a first part of the glue solution with the cathode active substance, to obtain a primary slurry; mixing and agitating a second part of the glue solution in the primary slurry, to obtain a secondary slurry; and mixing and agitating a third part of the glue solution in the secondary slurry, to obtain an cathode slurry of a lithium ion battery.

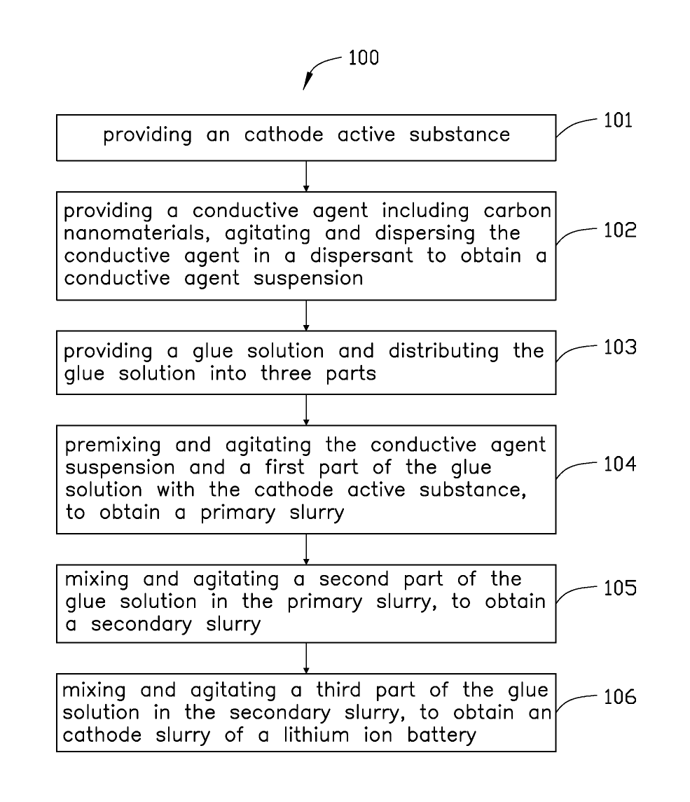

### CROSS-REFERENCE TO RELATED APPLICATIONS

This application claims priority to Taiwanese Patent Application No. 106112369 filed on Apr. 13, 2017, the contents of which are incorporated by reference herein.

### FIELD

The subject matter herein generally relates to a method for preparing cathode slurry of a lithium ion battery.

### BACKGROUND

A lithium ion battery is widely used for higher capacities, higher outputs, no memory effect, and longer cycle life. A lithium ion battery cathode is an important component of a lithium ion battery. Carbon black, graphite, or carbon nanomaterials are used in lithium ion battery cathode slurry to improve conductivity of active substances and to improve conductivity between active substances and collector. Carbon nanomaterials have a higher conductivity than carbon black and graphite.

### BRIEF DESCRIPTION OF THE DRAWING

Implementations of the present technology will now be described, by way of example only, with reference to the attached FIGURE.

The FIGURE is a flow chart of an exemplary embodiment of a method for preparing cathode slurry of a lithium ion battery.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain sections have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like.

The present disclosure is described in relation to a method for manufacturing a method for preparing cathode slurry of a lithium ion battery, including: providing an cathode active substance; providing a conductive agent including carbon nanomaterials, agitating and dispersing the conductive agent in a dispersant to obtain a conductive agent suspension; providing a glue solution and dividing the glue solution in three parts; premixing and agitating the conductive agent suspension and a first part of the glue solution with the cathode active substance, to obtain a primary slurry; mixing and agitating a second part of the glue solution in the primary slurry, to obtain a secondary slurry; and mixing and agitating a third part of the glue solution in the secondary slurry, to obtain an cathode slurry of a lithium ion battery.

Referring to the FIGURE, a flowchart shows an example embodiment for a method for preparing cathode slurry of a lithium ion battery. An example method 100 is provided by way of example, as there are a variety of ways to carry out the method. The method 100 described below can be carried out using the configurations illustrated in the FIGURE, for example, and various elements of these figures are referenced in explaining example method 100. Each block shown in the FIGURE represents one or more processes, methods, or subroutines, carried out in the exemplary method 100. Additionally, the illustrated order of blocks is by example only and the order of the blocks can change. The exemplary method 100 can begin at block 101.

At block 101, providing an cathode active substance.

The cathode active substance is formed by dry mixing active substance powder.

A time period of the dry mixing can be in a range from about 5 minutes to 15 minutes.

A main ingredient of the cathode active substance can be lithium iron phosphate, lithium cobalt oxide, lithium nickelate, or lithium manganese phosphate.

Preferably, the main ingredient of the cathode active substance is lithium cobalt oxide.

Preferably, the time period of the dry mixing is about 10 minutes.

At block 102, providing a conductive agent including carbon nanomaterials. Agitating and dispersing the conductive agent in a dispersant to obtain a conductive agent suspension.

Preferably, carbon nanomaterials are carbon nanotubes.

The conductive agent can further include graphite, carbon black, or a mixture thereof. The graphite can be TIMREX KS-6™ GRAPHITE (hereafter “KS-6”) produced by Timcal Graphite Corporation and the carbon black can be SUPER-P™ CONDUCTIVE CARBON BLACK (hereafter “Super-P”) produced by Timcal Graphite Corporation.

The dispersant can be ethanol or polyvinylpyrrolidone.

After agitating and dispersing in the dispersant, the carbon nanomaterials are separated and dispersed in the conductive agent suspension.

A revolution speed of a rotary mixing device for agitating and dispersing the conductive agent in the dispersant can be in a range from about 20 revolutions per minute to about 50 revolutions per minute; a rotation speed of the rotary mixing device for agitating and dispersing the conductive agent in the dispersant can be in a range from about 1000 revolutions per minute to about 2500 revolutions per minute.

Preferably, the revolution speed of a rotary mixing device for agitating and dispersing the conductive agent in the dispersant is about 30 revolutions per minute; the rotation speed of the rotary mixing device for agitating and dispersing the conductive agent in the dispersant is about 2000 revolutions per minute.

At block 103, providing a glue solution and dividing the glue solution into three parts.

A first part of the glue solution may take up in a range from about 20% to about 30% in total glue solution. A second part of the glue solution may take up in a range from about 25% to about 35% in total glue solution. A third part of the glue solution may take up in a range from about 35% to about 55% in total glue solution.

The glue solution can be a waterborne binder aqueous solution.

Alternatively, the glue solution can be an N-methylpyrrolidone solution of polyvinylidene fluoride.

At block 104, premixing and agitating the conductive agent suspension and the first part of the glue solution with the cathode active substance, to obtain a primary slurry.

A time period of premixing and agitating the conductive agent suspension and the first part of the glue solution with the cathode active substance can be in a range from about 60 minutes to about 120 minutes.

Preferably, the time period of premixing and agitating the conductive agent suspension and the first part of the glue solution with the cathode active substance is about 90 minutes.

A revolution speed of a rotary mixing device for premixing and agitating the conductive agent suspension and the first part of the glue solution with the cathode active substance can be in a range from about 20 revolutions per minute to about 50 revolutions per minute; a rotation speed of the rotary mixing device for premixing and agitating the conductive agent suspension and the first part of the glue solution with the cathode active substance can be in a range from about 1000 revolutions per minute to about 2500 revolutions per minute.

Preferably, the revolution speed of a rotary mixing device for premixing and agitating the conductive agent suspension and the first part of the glue solution with the cathode active substance is about 30 revolutions per minute; the rotation speed of the rotary mixing device for premixing and agitating the conductive agent suspension and the first part of the glue solution with the cathode active substance in the dispersant is about 1500 revolutions per minute.

At block 105, mixing and agitating the second part of the glue solution in the primary slurry, to obtain a secondary slurry.

A time period of mixing and agitating the second part of the glue solution in the primary slurry can be in a range from about 20 minutes to about 40 minutes.

Preferably, the time period of mixing and agitating the second part of the glue solution in the primary slurry is about 30 minutes.

A revolution speed of a rotary mixing device for mixing and agitating the second part of the glue solution in the primary slurry can be in a range from about 20 revolutions per minute to about 50 revolutions per minute; a rotation speed of the rotary mixing device for mixing and agitating the second part of the glue solution in the primary slurry can be in a range from about 1000 revolutions per minute to about 2500 revolutions per minute.

Preferably, the revolution speed of a rotary mixing device for mixing and agitating the second part of the glue solution in the primary slurry is about 30 revolutions per minute; the rotation speed of the rotary mixing device for mixing and agitating the second part of the glue solution in the primary slurry is about 1500 revolutions per minute.

At block 106, mixing and agitating the third part of the glue solution in the secondary slurry, to obtain an cathode slurry of a lithium ion battery.

A time period of mixing and agitating the third part of the glue solution in the secondary slurry can be in a range from about 20 minutes to about 40 minutes.

Preferably, the time period of mixing and agitating the third part of the glue solution in the secondary slurry is about 30 minutes.

A revolution speed of a rotary mixing device for mixing and agitating the third part of the glue solution in the secondary slurry can be in a range from about 20 revolutions per minute to about 50 revolutions per minute; a rotation speed of the rotary mixing device for mixing and agitating the third part of the glue solution in the secondary slurry can be in a range from about 1000 revolutions per minute to about 2500 revolutions per minute.

Preferably, the revolution speed of a rotary mixing device for mixing and agitating the third part of the glue solution in the secondary slurry is about 30 revolutions per minute; the rotation speed of the rotary mixing device for mixing and agitating the third part of the glue solution in the secondary slurry is about 1500 revolutions per minute.

### EXAMPLE 1

A method for preparing cathode slurry of a lithium ion battery includes the following steps.

An cathode active substance is provided by dry mixing lithium cobalt oxide powder for about 10 minutes.

A conductive agent including carbon nanotubes and Super-P is provided. Then, the conductive agent is agitated and dispersed in ethanol, thereby obtaining a conductive agent suspension.

A glue solution, which is a waterborne binder aqueous solution, is provided and then is divided in three parts. A first part of the glue solution takes up about 25% in total glue solution. A second part of the glue solution takes up about 30% in total glue solution. A third part of the glue solution takes up about 45% in total glue solution.

The conductive agent suspension and the first part of the glue solution is premixed and agitated with the cathode active substance, to obtain a primary slurry.

A time period of premixing and agitating the conductive agent suspension and the first part of the glue solution with the cathode active substance is about 90 minutes.

A revolution speed of a rotary mixing device for premixing and agitating the conductive agent suspension and the first part of the glue solution with the cathode active substance is about 30 revolutions per minute, and a rotation speed of the rotary mixing device for premixing and agitating the conductive agent suspension and the first part of the glue solution with the cathode active substance in the dispersant is about 1500 revolutions per minute.

The second part of the glue solution is mixed and agitated in the primary slurry, to obtain a secondary slurry.

A time period of mixing and agitating the second part of the glue solution in the primary slurry is about 30 minutes. A revolution speed of a rotary mixing device for mixing and agitating the second part of the glue solution in the primary slurry is about 30 revolutions per minute, and a rotation speed of the rotary mixing device for mixing and agitating the second part of the glue solution in the primary slurry is about 1500 revolutions per minute.

The third part of the glue solution is mixed and agitated in the secondary slurry, to obtain an cathode slurry of a lithium ion battery.

A time period of mixing and agitating the third part of the glue solution in the secondary slurry is about 30 minutes. A revolution speed of a rotary mixing device for mixing and agitating the third part of the glue solution in the secondary slurry is about 30 revolutions per minute, and a rotation speed of the rotary mixing device for mixing and agitating the third part of the glue solution in the secondary slurry is about 1500 revolutions per minute.

### EXAMPLE 2

A method for preparing cathode slurry of a lithium ion battery includes the following steps.

An cathode active substance is provided by dry mixing lithium cobalt oxide powder for about 10 minutes.

A conductive agent including carbon nanotubes and KS-6 is provided. Then, the conductive agent is agitated and dispersed in polyvinylpyrrolidone, thereby obtaining a conductive agent suspension.

A glue solution, which is an N-methylpyrrolidone solution of polyvinylidene fluoride, is provided and then is divided in three parts. A first part of the glue solution takes up about 30% in total glue solution. A second part of the glue solution takes up about 30% in total glue solution. A third part of the glue solution takes up about 40% in total glue solution.

The conductive agent suspension and the first part of the glue solution is premixed and agitated with the cathode active substance, to obtain a primary slurry.

A time period of premixing and agitating the conductive agent suspension and the first part of the glue solution with the cathode active substance is about 90 minutes.

A revolution speed of a rotary mixing device for premixing and agitating the conductive agent suspension and the first part of the glue solution with the cathode active substance is about 30 revolutions per minute; a rotation speed of the rotary mixing device for premixing and agitating the conductive agent suspension and the first part of the glue solution with the cathode active substance in the dispersant is about 1500 revolutions per minute.

The second part of the glue solution is mixed and agitated in the primary slurry, to obtain a secondary slurry.

A time period of mixing and agitating the second part of the glue solution in the primary slurry is about 30 minutes. A revolution speed of a rotary mixing device for mixing and agitating the second part of the glue solution in the primary slurry is about 30 revolutions per minute; a rotation speed of the rotary mixing device for mixing and agitating the second part of the glue solution in the primary slurry is about 2000 revolutions per minute.

The third part of the glue solution is mixed and agitated in the secondary slurry, to obtain an cathode slurry of a lithium ion battery.

A time period of mixing and agitating the third part of the glue solution in the secondary slurry is about 30 minutes. A revolution speed of a rotary mixing device for mixing and agitating the third part of the glue solution in the secondary slurry is about 40 revolutions per minute; a rotation speed of the rotary mixing device for mixing and agitating the third part of the glue solution in the secondary slurry is about 2000 revolutions per minute.

Cathode slurry of a lithium ion battery obtained in example 1 and example 2 all have a structure distributed in grid, and the carbon nanomaterials are separated and dispersed in the cathode slurry of a lithium ion battery.

The exemplary embodiments shown and described above are only examples. Many details are often found in the art such as the other features of a method for preparing cathode slurry of a lithium ion battery. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the sections within the principles of the present disclosure, up to and including the full extent established by the broad general meaning of the terms used in the claims. It will therefore be appreciated that the exemplary embodiments described above may be modified within the scope of the claims.

What is claimed is:

1. A method for preparing cathode slurry of a lithium ion battery, comprising:
providing an cathode active substance;
providing a conductive agent including carbon nanomaterials, agitating and dispersing the conductive agent in a dispersant to obtain a conductive agent suspension;
providing a glue solution and dividing the glue solution into three parts;
premixing and agitating the conductive agent suspension and a first part of the glue solution with the cathode active substance, to obtain a primary slurry;
mixing and agitating a second part of the glue solution in the primary slurry, to obtain a secondary slurry; and
mixing and agitating a third part of the glue solution in the secondary slurry, to obtain an cathode slurry of a lithium ion battery.

2. The method of claim 1, wherein the cathode active substance is formed by dry mixing active substance powder.

3. The method of claim 1, wherein a time period of the dry mixing is in a range from about 5 minutes to 15 minutes.

4. The method of claim 1, wherein a main ingredient of the cathode active substance is lithium iron phosphate, lithium cobalt oxide, lithium nickelate, or lithium manganese phosphate.

5. The method of claim 1, wherein a revolution speed of a rotary mixing device for agitating and dispersing the conductive agent in the dispersant is in a range from about 20 revolutions per minute to about 50 revolutions per minute; a rotation speed of the rotary mixing device for agitating and dispersing the conductive agent in the dispersant is in a range from about 1000 revolutions per minute to about 2500 revolutions per minute.

6. The method of claim 1, wherein the dispersant is ethanol or polyvinylpyrrolidone.

7. The method of claim 1, wherein the conductive agent further comprises graphite, carbon black, or a mixture thereof.

8. The method of claim 7, wherein the conductive agent comprises carbon nanotubes and carbon black.

9. The method of claim 1, wherein the first part of the glue solution is in a range from about 20% to about 30% in total glue solution, the second part of the glue solution is in a range from about 25% to about 35% in total glue solution, and the third part of the glue solution is in a range from about 35% to about 55% in total glue solution.

10. The method of claim 1, wherein the glue solution is a waterborne binder aqueous solution, or a solution of polyvinylidene fluoride.

11. The method of claim 1, wherein a time period of premixing and agitating the conductive agent suspension and the first part of the glue solution with the cathode active substance is in a range from about 60 minutes to about 120 minutes.

12. The method of claim 1, wherein a revolution speed of a rotary mixing device for premixing and agitating the conductive agent suspension and the first part of the glue solution with the cathode active substance is in a range from about 20 revolutions per minute to about 50 revolutions per minute; wherein a rotation speed of the rotary mixing device for premixing and agitating the conductive agent suspension and the first part of the glue solution with the cathode active substance is in a range from about 1000 revolutions per minute to about 2500 revolutions per minute.

13. The method of claim 1, wherein a time period of mixing and agitating the second part of the glue solution in the primary slurry is in a range from about 20 minutes to about 40 minutes.

14. The method of claim 1, wherein a revolution speed of a rotary mixing device for mixing and agitating the second part of the glue solution in the primary slurry is in a range from about 20 revolutions per minute to about 50 revolutions per minute; wherein a rotation speed of the rotary mixing device for mixing and agitating the second part of the glue solution in the primary slurry is in a range from about 1000 revolutions per minute to about 2500 revolutions per minute.

15. The method of claim 1, wherein a time period of mixing and agitating the third part of the glue solution in the secondary slurry is in a range from about 20 minutes to about 40 minutes.

16. The method of claim 1, wherein a revolution speed of a rotary mixing device for mixing and agitating the third part of the glue solution in the secondary slurry is in a range from about 20 revolutions per minute to about 50 revolutions per minute; wherein a rotation speed of the rotary mixing device for mixing and agitating the third part of the glue solution in the secondary slurry is in a range from about 1000 revolutions per minute to about 2500 revolutions per minute.
